(19) United States
(12) Patent Application Publication
(10) Pub. No.: US 2005/0266308 A1
(43) Pub. Date: Dec. 1, 2005

(54) Conductive element between terminal and collector

(75) Inventors: Jon K. West, Gainesville, FL (US); Thomas J. McCall, Ft. White, FL (US); Thomas E. Audit, Alachua, FL (US)

Correspondence Address: MORRISON & FOERSTER LLP, 1650 TYSONS BOULEVARD, SUITE 300, MCLEAN, VA, 22102, US

(73) Assignee: WAVECREST LABORATORIES, Dulles, VA (US)

(21) Appl. No.: 10/853,769

(22) Filed: May 26, 2004

(51) Int. Cl. H01M 2/26; H01B 1/00

(52) U.S. Cl. 429/161; 29/825; 174/68.1

(57) ABSTRACT

A collector to terminal conductive element, or tab, for use with multiple-contact current collectors in the manufacture and use of energy storage cells. The collector to terminal conductive element of the present invention provides for lower internal resistance and higher conductivity than previous positive devices, thereby achieving higher current handling capacity and lower discharge temperatures. The conductive element of the present invention is manufactured separately from the collector itself, to avoid problems with alignment during the process of connecting the collector to the energy storage device and to facilitate the tab's connection to the cell terminal. In one preferred embodiment, the terminal to collector conductive element is useful for creating current paths between the anode of a coiled cell energy storage device and a battery terminal.

### FIELD OF THE INVENTION

The present invention, in a preferred embodiment, relates to a device for creating current paths between a positive current collector and terminal, for use in electrolytic energy storage devices that may comprise single or multi-cell batteries. Disclosed is a novel conductive element, also occasionally referred to as a “tab,” between the collector and the terminal, and a method for assembling an energy storage cell with such a conductive element that may permit such a cell to achieve higher current and power output at lower temperatures.

### BACKGROUND OF THE RELATED ARTS

Batteries are conventionally constructed with a set of anode plates and a set of interleafing cathode plates, which may be spirally wound and spaced apart by separators infused with an electrolyte. The anode plates are electrically connected to the battery anode terminal, and the cathode plates are electrically connected to the battery cathode terminal. These portions of the energy storage cell comprise the positive and negative terminals of the cell. For the sake of rigidity of the assembled sets of anode and cathode plates, the connection between the plates and the terminals is typically mechanical as well as electrical, and is accomplished with a current collector that can take various forms.

The electromechanical attachment of the anode and cathode plates to their respective current collectors can be labor intensive and can be a source of quality control problems during battery construction. Ideally, the current assembly would rigidly support the plates to help prevent their deformation within the battery case and to resist vibrational damage to the plates and separators. Further, the current conductive element should be formed of a material that is readily connectable to both the terminal and to the plates in a manner that assures an easy and dependable electrical and mechanical attachment. It is important that the electrical connection to both the plates and the collectors be of low resistance or at least of a resistance no greater than the resistance in the plates and terminals themselves, so that the impedance of the connection is reduced and the current capacity is increased.

One desirable electrical characteristic of such batteries is a very high charge and discharge rate. A high charge and discharge rate requires high current carrying capacity in the electrical connection from the plates to the terminals, in order to both carry the load without reducing the charge and discharge rate and also to avoid resistive overheating that could structurally or electrically damage the battery.

The prior art discloses many types of end connectors that are designed to enhance the structural integrity or to minimize the electrical impedance of batteries. For example, U.S. Pat. No. 4,539,273 by Goebel describes a set of plates wound on a spool with an anode flange and a cathode flange. Each plate has a set of connecting tabs spaced along an edge, which is in electrical contact with the appropriate spool flange. The Goebel device does not provide for any secure mechanical connection between the spool flange and the plates. Also, the Goebel device would appear to require a fairly intricate manufacturing process, especially if used on a very thin plate battery having a very long plate edge that would require a large number of connecting tabs.

In U.S. Pat. No. 3,695,935 by Cromer, there is disclosed a spirally wound plate design where the anode plate is wound offset from the cathode plate so that the anode plate edge overhangs one edge of the spiral, and the cathode plate edge overhangs the other edge of the spiral. The two overhanging edges are “ruffled”. The purpose of the ruffles is said to be to strengthen the edges against damage during manufacturing, to blunt the edges to reduce the potential for injuring manufacturing workmen, and to increase the conductivity between the plate and the terminal. The Cromer device uses an ordinary strap type end connector to join the plates to the terminal.

One of the more common arrangements for electrically connecting the plates to the terminals is shown in U.S. Pat. No. 3,862,861 by McClelland et al. In the structure shown by McClelland, the plates include spaced tabs on the plate edge so that the wound plate has a set of tabs protruding from an end. The protruding tabs are then joined together and connected to the current collector. The McClelland arrangement is difficult to construct, may allow for electrolyte leakage, and may not lend toward high conductivity.

One significant factor not accounted for in the prior art is the relationship between conductivity and the contact area between the positive electrode and the positive current collector. It would be desirable to have a design for a positive current collector that provides multiple points of contact between the collector and the electrode to increase the conductivity of the electrode and to decrease the internal resistance of the contact area between the electrode and collector. Also, it would be desirable to create a current path between the collector and the cover that further reduces the internal resistance of an energy storage device. It may also be desirable to increase the mechanical stability and reliability of the energy storage device, increase the vibration resistance of the cell and reduce the risk that the cell will come apart.

Moreover, positive current collectors of the prior art generally comprise a circular hub having a plurality of weld points and a protruding conductive element for connection to the battery cover. During assembly, such a collector must be carefully aligned prior to being welded to the coil, so that the integrated conductive element can be attached to the cover and then folded in a manner that permits the cover to be placed on the can. The alignment process can be difficult and, if not done correctly, may inhibit a secure seal between the cover and the can. It is therefore desirable to have a positive collector that does not require alignment during the battery assembly process. It is further desirable to provide a collector without an integrated tab.

The protruding conductive element of prior art collectors, as shown in FIG. 1, generally includes a slit to create a sacrificial portion that is burned away during the welding process to avoid creating a short circuit for the welding current. At the point where the conductive element meets the circular hub of the collector, however, it is possible for at least one, if not both, of the metal surfaces to burn away during the melding process or to lose structural integrity. If one of these portions breaks, which is often the case, the current carrying capacity of the battery is greatly reduced. If both break, the battery fails. If this occurs during the manufacturing process, it adds to the manufacturer's reject rate. It is therefore desirable to provide a system for creating a current path between the positive collector and battery cover that is not easily susceptible to failure.

By failing to provide for high conductivity at the current collectors, prior art devices can exhibit high effective resistance which, in turn, leads to higher heat discharge and lower efficiency.

It is also desirable to provide a current collector that has high conductivity with low resistance in a single cell energy source.

It is also desirable to provide a current collector that reduces temperature during discharge of a single cell energy source.

As well, it is desirable to provide a current collector that facilitates alignment and orientation of single cell energy sources when processed or assembled into multi-cell batteries.

### SUMMARY OF THE INVENTION

In one illustrative embodiment, a device in accordance with the present invention may be characterized as a conductive element having two regions. A first region may be configured for establishing at least one current path between the conductive element and a terminal of an energy storage device. In some instances the terminal will correspond to the cover of the energy storage device. However, the present invention is not limited to embodiments in which the terminal is the cover. A second region may be configured for establishing at least one current path between the conductive element and a current collector of the energy storage device. In this embodiment the current collector may have a radially symmetric configuration. The terminal and the current collector may be configured for arrangement along a common axis. At least one current path between the terminal and the current collector may thereby be established via the conductive element irrespective of orientation of the first region of the conductive element relative to the axis common to the terminal and the current collector. While the current collector may have a radially symmetric configuration in this embodiment, it should be appreciated that the present invention may be employed in energy storage devices having a variety of different configurations including, for example, non-radial, non-cylindrical, prismatic and oval cells.

In another embodiment, one or more current paths between the conductive element and the current collector may be established after establishing one or more current paths between an electrode of the energy storage device and the current collector. Alternatively, one or more current paths between the conductive element and the current collector may be established after an electrode of the energy storage device and the current collector are mutually positioned. The energy storage device may include an electrode and a container and at least one current path between the conductive element and the current collector that is established after the electrode, the current collector and the container are mutually positioned.

The conductive element may establish one or more current paths between the conductive element and the current collector after one or more current paths have been established between the conductive element and the terminal.

Further, there may be one or more surface variations in the first region of the conductive element configured to increase or enhance the current paths between the conductive element and the terminal. The conductive element may, in another illustrative embodiment, include one or more surface variations in the second region configured to increase or enhance the current paths between the conductive element and the terminal. The conductive element may establish more than one current path between the conductive element and the terminal.

The conductive element may include an area of contact between the conductive element and the terminal and may include at least one surface variation in the first region configured to increase the area of contact between the conductive element and the terminal. Such a conductive element may also include at least one surface variation in the second region configured to enhance the current paths between the conductive element and the current collector.

Further, an illustrative conductive element may have at least one surface variation in the second region of the conductive element configured to increase the number of current paths between the conductive element and the current collector, wherein the number of current paths between the conductive element and the current collector is greater than one.

Another conductive element of the present invention may have an area of contact between the conductive element and the current collector and at least one surface variation in the second region of the conductive element configured to increase the area of contact between the conductive element and the current collector. The conductive element may have at least one aperture disposed in the conductive element between the first region and the second region. The conductive element may be characterized as having a first region that includes at least one surface variation for establishing at least one current path between the conductive element and the terminal and a second region that includes at least one surface variation for establishing at least one current path between the conductive element and the current collector. In another illustrative embodiment the number of surface variations for establishing one or more current paths between the conductive element and the terminal is greater than the number of surface variations for establishing one or more current path or paths between the conductive element and the current collector.

In another embodiment the conductive element is deformable. Further, the conductive element may be deformable into an S-shaped configuration. As well, the conductive element may be deformable into a Z-shaped configuration, W-shaped configuration, etc.

The conductive element may also adjoin or be adjacent to a terminal having a central region and wherein the first region of the conductive element is configured for establishing at least one current path between the conductive element and the central region of the terminal. In another embodiment, the conductive element contacts a current collector having a central region and wherein the second region of the conductive element is configured for establishing at least one current path between the conductive element and the central region of the current collector.

In another embodiment, the invention relates to a method of making a plurality of tabs. The method may include the following steps, although the order in which the steps are performed may be varied. The steps may include, providing a conductive material, forming from the conductive material one or more first regions configured for establishing at least one current path with a terminal of an energy storage device, forming from the conductive material one or more second regions configured for establishing at least one current path with a current collector of the energy storage device, and separating at least one first region and at least one associated second region from the conductive material.

An energy storage device, in an embodiment of a device in accordance with the present invention, may include a terminal, a current collector with a radially symmetric configuration, the terminal and the current collector being configured for arrangement along a common axis, and a tab, the conductive element of the conductive element having a first region configured for establishing at least one current path between the conductive element and the terminal and a second region configured for establishing at least one current path between the conductive element and the current collector. According to this embodiment of a device in accordance with the present invention, at least one current path between the terminal and the current collector may be established via the conductive element irrespective of orientation of the first region of the conductive element relative to the axis common to the terminal and the current collector.

Further, the energy storage device may have at least one current path between the conductive element and the current collector that is established after at least one current path between an electrode of the energy storage device and the current collector is established. As well, the energy storage device may include at least one current path between the conductive element and the current collector that is established after an electrode of the energy storage device and the current collector are mutually positioned.

The energy storage device may include an electrode and a container, wherein the at least one current path between the conductive element and the current collector is established after the electrode, the current collector and the container are mutually positioned. The energy storage device may also include at least one current path between the conductive element and the current collector that is established after the at least one current path between the conductive element and the terminal is established.

Another illustrative energy storage device may include one or more surface variations in the first region of the conductive element configured to enhance one or more current paths between the conductive element and the terminal. Also, the energy storage device may have one or more surface variations in the first region of the conductive element configured to increase the number of current paths between the conductive element and the terminal. The energy storage device may have a number of current paths between the conductive element and the terminal that is greater than one.

Another energy storage device may include an area of contact between the conductive element and the terminal and have one or more surface variations in the first region of the conductive element configured to increase the area of contact between the conductive element and the terminal. And yet another energy storage device may have one or more surface variations in the second region of the conductive element configured to enhance one or more current paths between the conductive element and the current collector. Another energy storage device may include one or more surface variations in the second region of the conductive element configured to increase the number of current paths between the conductive element and the current collector. Preferably, the energy storage device may have more than one current path between the conductive element and the current collector.

Another illustrative energy storage device may include an area of contact between the conductive element and the current collector and have one or more surface variations in the second region of the conductive element configured to increase the area of contact between the conductive element and the current collector. At least one aperture may be disposed in the conductive element between the first region and the second region. The first region may have one or more surface variations for establishing at least one current path between the conductive element and the terminal, and the second region may include one or more surface variations for establishing at least one current path between the conductive element and the current collector. The plurality of surface variations for establishing at least one current path between the conductive element and the terminal may be greater than the number of surface variations for establishing at least one current path between the conductive element and the current collector.

Another embodiment in accordance with the present invention relates to making an energy storage device. Although the order of the steps may be changed, a preferred method may include providing a terminal and providing a current collector. The terminal and the current collector may be configured for arrangement along a common axis. A conductive element may be provided for creating at least one current path between the collector and the terminal. The conductive element may have a first region configured for establishing at least one current path between the conductive element and the terminal. The conductive element may have a second region configured for establishing at least one current path between the conductive element and the current collector. At least one current path may be established between the terminal and the current collector via the conductive element irrespective of orientation of the first region of the conductive element relative to the common axis.

### BRIEF DESCRIPTION OF THE DRAWING FIGURES

FIG. 1(a) illustrates an embodiment of a positive current collector according to the prior art having an integrated collector to cover tab.

FIG. 1(b) illustrates a current collector having an integrated collector to cover tab in a position wherein the cover and collector tab are in contact.

FIGS. 2(a)-(c) show detailed views of an embodiment of a cover to collector terminal according to the present invention, including exemplary weld projections.

FIGS. 3(a), 3(b), and 3(c) illustrate the tab, shown in detail in FIG. 3(c), to cover weld process in top plan and side plan view.

FIG. 4(a) shows a battery cover and collector to cover tab in a position suitable for welding to the collector.

FIG. 4(b) shows a multiple contact current collector adjacent to a cover to collector tab that has been bent.

FIG. 5 shows, in cross section, an embodiment of a battery according to the present invention.

FIG. 6 shows an example of an energy storage coil in top plan view.

FIGS. 7(a)-7(c) illustrate a multiple contact current collector having a plurality of weld projections that may be manufactured in a strip, as well as exemplary weld projections.

### DETAILED DESCRIPTION OF THE INVENTION

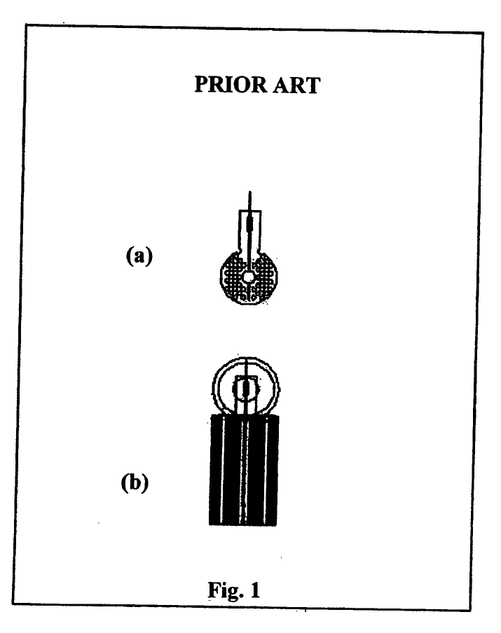

The present invention relates to an electrical energy storage device and, more specifically, to rechargeable storage cells such as D-Cell batteries. By way of example and illustration, the present specification describes D-Cell batteries. It is noted, however, each of the principles and discoveries mentioned herein apply with equal weight to cells having a coiled energy storage device, such as AA, AAA, C, and other cells, such as prismatic cells, for example, which do not employ coiled cores. Particularly, the present invention is a novel current collector and method for creating current paths between the positive collector and battery terminal and for providing a low-resistance current path from the electrode coil to the terminal. Although not limited to these advantages, the present invention overcomes the labor-intensive and failure-prone nature of prior art collectors, such as the collector shown in FIG. 1, and provides for a battery that emits less heat during charge and discharge by having a lower internal resistance than prior art batteries.

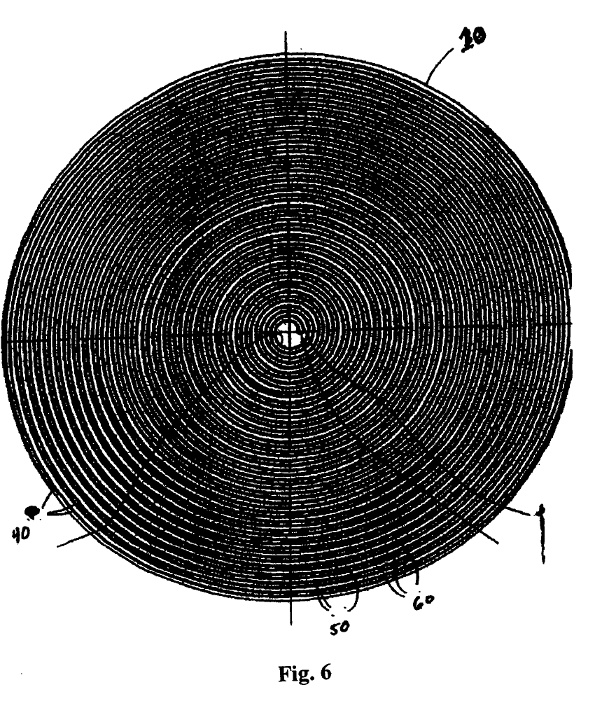

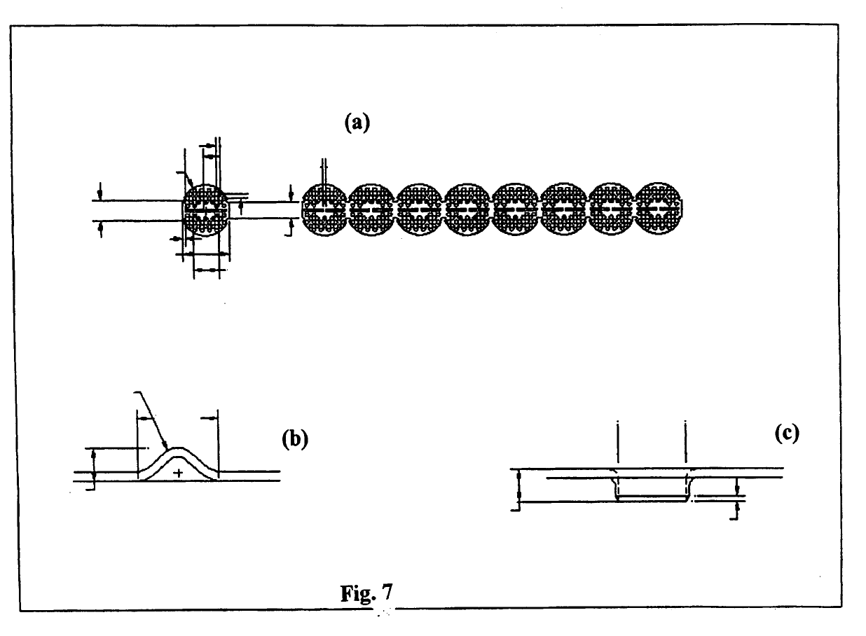

As illustrated by FIG. 6, an exemplary energy storage cell of the present invention includes a coiled energy storage device 10, a positive current collector 1, a positive current collector to terminal tab 3, a negative current collector 2, and a conducting casing, or “can” 20. The can 20 is preferably chemically compatible with the electrochemistry of the storage device, and thus be substantially resistant and impermeable to the electrolyte used. Any such suitable material may be employed as the casing.

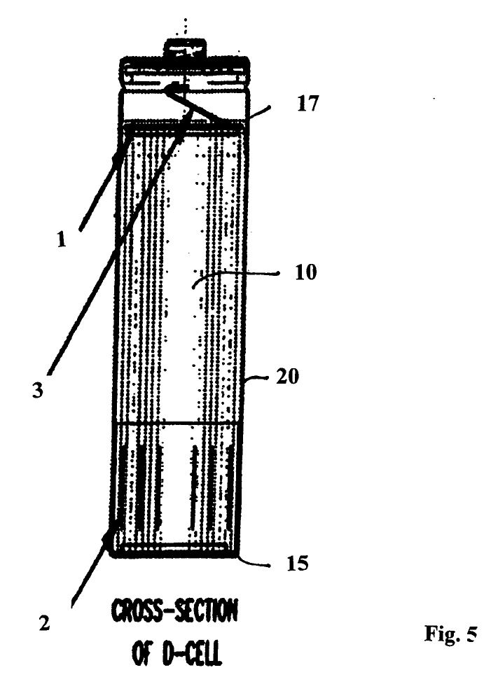

The electrical energy storage device, shown generally in FIG. 5 and noting that like parts are shown with corresponding reference numerals throughout the drawing figures, may comprise a coiled winding 10 having a cathode plate including a strip having a pair of elongated side edges, an anode plate including a strip having a pair of elongated side edges, and a separator located between the cathode and anode plates. Further, in an illustrative description of an energy storage device, it includes a coiled winding 10 made of three or more elongated rectangular strips wound together (depending on whether one or two separators are used): a cathode plate 40, an anode plate 50 and a separator 60. The separator 60 is wound between the cathode plate 40 and the anode plate 50 along their entire lengths to prevent the plates from contacting each other. The cathode plate 40 and the anode plate 50 each have two elongated side edges which extend along the entire lengths of the longest sides of the plates. Exemplary energy storage devices and methods which related to the present invention are described in U.S. Pat. No. 6,265,098, U.S. Pat. No. 5,667,907, U.S. Pat. No. 5,439,488, and U.S. Pat. No. 5,370,711, each of which hereby incorporated by reference in its entirety.

To provide a surface upon which each of the current collectors may be attached to the energy storage device, the cathode plate and the anode plate are wound in an offset relationship so that one elongated side edge of the cathode plate extends beyond one elongated side edge of the anode plate at a first side of the winding, and the other elongated side edge of the anode plate extends beyond the other elongated side edge of the cathode plate at a second side of the winding opposite the first side. The cathode plate and the anode plate are wound in an offset relationship so that the edge of the cathode plate extends beyond the edge of the anode plate at the circular first side of the winding. Similarly, at the circular second side of the winding, the other edge of the anode plate extends beyond the other edge of the cathode plate. Therefore, the edge of the cathode plate forms a spiral surface at the first side of the winding, and the edge of the anode plate forms a spiral surface at the second side of the winding.

Once the collectors are attached to the energy storage device and the device has been secured in the casing, an electrolyte material is introduced within the winding. A liquid electrolyte material is located between the plates in the winding and saturates the separator. If the plates are porous, the electrolyte material may also enter the pores to improve the output of the device. The electrolyte material can then be sealed within the casing to prevent leakage.

The electrolyte material allows the desired electrochemical reaction to occur within the winding. If the plates are made of nickel hydroxide and cadmium, the electrolyte material may comprise an aqueous alkaline solution such as potassium hydroxide. However, any suitable electrolyte which performs favorably in combination with the materials chosen as the plates may be used within the scope of the present invention.

Two current collectors may be secured to the casing, one current collector being pressed against the first side of the winding to contact the cathode plate at a plurality of locations thereon, and the other current collector being pressed against the second side of the winding to contact the anode plate at a plurality of locations thereon. As illustratively embodied in FIG. 5, two current collectors 1 and 2 are pressed against the ends of the winding 10 to contact the respective plate edges. A negative current collector 2 is pressed against the first side 15 of the winding 10 to contact the cathode plate 40 and a positive current collector 1 is pressed against the second end 17 of the winding 10 to contact the anode plate 50. The offset relationship between the plates allows each current collector 1 and 2 to make direct electrical contact with a single plate without the need for tabs connecting the plates and collectors. However, in order to increase the current carrying capacity between the negative current collector and the cathode plate, it has been found to be advantageous to provide tabs that radially protrude from a central hub, or inner region of the collector, that can be folded to receive the cathode plate. Such a configuration is described in applicant's copending applications, U.S. Ser. No. ______, U.S. Ser. No. ______, and U.S. Ser. No. ______, which are hereby incorporated by reference in their entireties.

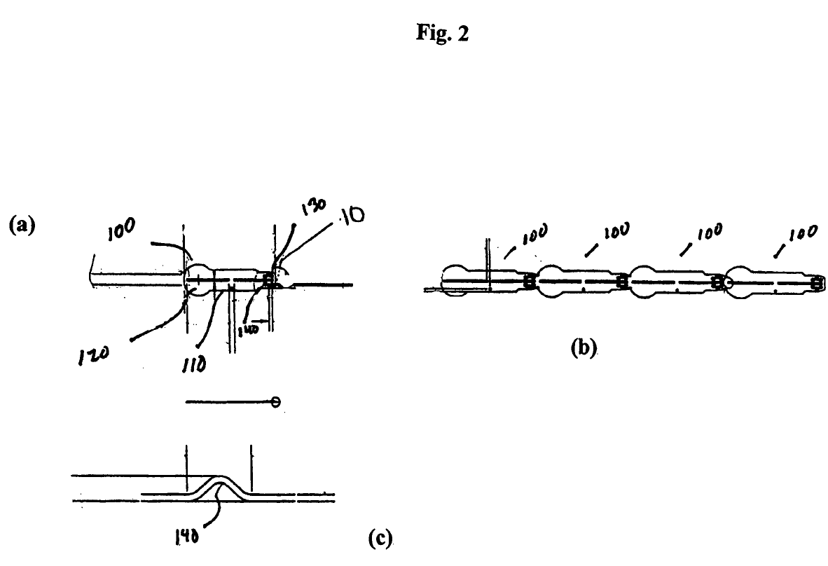

As shown in FIG. 2(a)-2(c), the positive current collector may preferably comprise a plate having multiple protrusions arranged around its perimeter that abut the positive winding of the cell. These protrusions are subsequently welded to the positive winding via the plurality of weld projections provided thereon. A preferred positive current collector of the present invention also may include projections and dimples, collectively “surface variations”, to increase the conductive contact area between the collector and the winding, thereby lowering the internal resistance of the contact area between the winding and the collector and improving the heat rejection of the cell during discharge. The increased conductivity that results from the preferred collector permits for increased current capacity, as much as six times as much capacity with a similar temperature rise as that permitted by prior art positive current collectors.

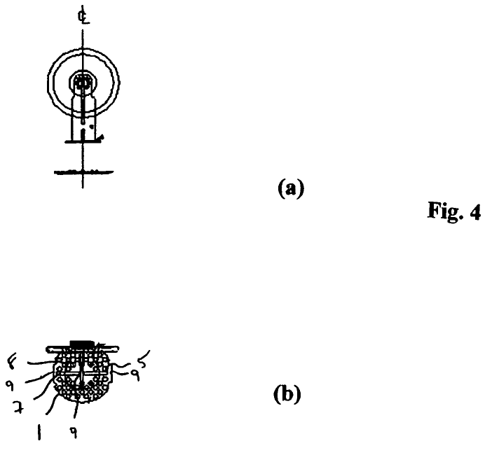

Further, when a series weld is made, it is desirable that the current delivered by the welding apparatus does not short circuit through the article being welded. Accordingly, the positive current collector of the present invention, with reference to FIG. 4(b), may also include slots 7, or air gaps, where the current cannot flow. To hold the collector 2 together, small mechanical bridges 9 may be provided which are permitted to burn away during the welding process. After these bridges 9 have been sacrificed, there is no path for which the welding current to short circuit, forcing the current to travel through the central hub 8 of the collector, through the weld projections 5 and to the coil 10 (shown in FIG. 6). The current then travels back through the weld projections 5 into the other side of the collector. The weld projections 5 concentrate the current in the smallest physical area, creating a molten weld area.

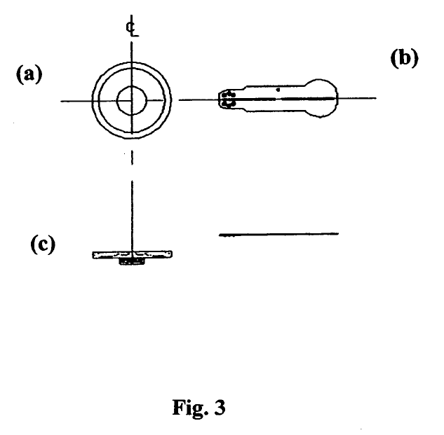

Since the positive collector of the present invention does not require an integrated tab, thereby reducing the need to align the positioning of the collector prior to creating the current paths between the collector and coil, a separate cover to the collector tab may be provided. Such a tab is shown in FIGS. 3(a)-(c), 4(a)-(b), and, in greater detail FIGS. 2(a)-(c). FIG. 4(a) illustrates one possible position of the cover to collector tab. As shown in FIG. 2(a), the cover to collector tab 100, in one illustrative embodiment, may be described as being an elongated metal strip 110 having a circular hub 120 for contacting a positive current collector and end portion 130 for contacting the inside of the battery cover. Both the hub 120 and end portion 130 may be provided with a plurality of weld projections 140 for forming mechanically strong connections between the tab and collector or tab and cover and for providing low resistance current paths between the collector, through the tab, to the cover. As well, the tab may be provided with a slit, or air gap, having sacrificial metal bridges that burn away during the welding process, to eliminating short circuiting of the weld current through the tab, thereby forcing the welding current through the weld projections when securing the hub 120 to the collector or end portion 130 to the cover. As well, since it is not necessary to secure the tab to the collector until after the collector has been secured to the coil, alignment procedures during the manufacturing process are eliminated and the cover may be secured to the tab and the tab folded to allow the cover to be securely contacted with the casing.

An energy storage device comprising a conductive element in accordance with the present invention may be used for storing and supplying energy in a variety of different environments and for a variety of different purposes. For example, an energy storage device comprising a conductive element in accordance with the present invention may be used for storing and supplying energy in transportation vehicles, including, for example, ground transportation vehicles, air transportation vehicles, water surface transportation vehicles, underwater transportation vehicles, and other transportation vehicles. An energy storage device comprising a conductive element in accordance with the present invention may be used for storing and supplying energy in communication and entertainment devices, including for example telephones, radios, televisions and other communication and entertainment devices. An energy storage device comprising a conductive element in accordance with the present invention may be used for storing and supplying energy in home appliances, including for example flashlights, emergency power supplies, and other home appliances. The examples described in this paragraph are merely representative, not definitive.

1. A conductive element comprising:
a first region configured for establishing at least one current path between the conductive element and a terminal of an energy storage device,
a second region configured for establishing at least one current path between the conductive element and a current collector of the energy storage device,
the terminal and the current collector being configured for arrangement relative to a common axis,
whereby at least one current path between the terminal and the current collector is established via the conductive element irrespective of orientation of the conductive element relative to the common axis.

2. The conductive element of claim 1, wherein the at least one current path between the conductive element and the current collector is established after at least one current path between an electrode of the energy storage device and the current collector is established.

3. The conductive element of claim 1, wherein the at least one current path between the conductive element and the current collector is established after an electrode of the energy storage device and the current collector are mutually positioned.

4. The conductive element of claim 1, wherein the energy storage device comprises an electrode and a container and wherein the at least one current path between the conductive element and the current collector is established after the electrode, the current collector and the container are mutually positioned.

5. The conductive element of claim 1, wherein the at least one current path between the conductive element and the current collector is established after the at least one current path between the conductive element and the terminal is established.

6. The conductive element of claim 1 comprising at least one surface variation in the first region of the conductive element configured to enhance at least one current path between the conductive element and the terminal.

7. The conductive element of claim 1 comprising at least one surface variation in the first region of the conductive element configured to increase the number of current paths between the conductive element and the terminal.

8. The conductive element of claim 1 wherein the number of current paths between the conductive element and the terminal is not less than 2.

9. The conductive element of claim 1 comprising an area of contact between the conductive element and the terminal and comprising at least one surface variation in the first region of the conductive element configured to increase the area of contact between the conductive element and the terminal.

10. The conductive element of claim 1 comprising at least one surface variation in the second region of the conductive element configured to enhance at least one current path between the conductive element and the current collector.

11. The conductive element of claim 1 comprising at least one surface variation in the second region of the conductive element configured to increase the number of current paths between the conductive element and the current collector.

12. The conductive element of claim 1 wherein the number of current paths between the conductive element and the current collector is not less than 2.

13. The conductive element of claim 1 comprising an area of contact between the conductive element and the current collector and comprising at least one surface variation in the second region of the conductive element configured to increase the area of contact between the conductive element and the current collector.

14. The conductive element of claim 1 comprising at least one aperture disposed in the conductive element between the first region and the second region.

15. The conductive element of claim 1 wherein the first region comprises at least one surface variation for establishing at least one current path between the conductive element and the terminal and wherein the second region comprises at least one surface variation for establishing at least one current path between the conductive element and the current collector.

16. The conductive element of claim 15 wherein the at least one surface variation for establishing at least one current path between the conductive element and the terminal comprises a first plurality of surface variations, wherein the at least one surface variation for establishing at least one current path between the conductive element and the current collector comprises a second plurality of surface variations, and wherein the first plurality is greater than the second plurality.

17. The conductive element of claim 1 wherein the conductive element is deformable.

18. The conductive element of claim 17 wherein the conductive element is deformable into an S-shaped configuration.

19. The conductive element of claim 17 wherein the conductive element is deformable into a Z-shaped configuration.

20. The conductive element of claim 1 wherein the terminal comprises a central region and wherein the first region of the conductive element is configured for establishing at least one current path between the conductive element and the central region of the terminal.

21. The conductive element of claim 1 wherein the current collector comprises a central region and wherein the second region of the conductive element is configured for establishing at least one current path between the conductive element and the central region of the current collector

22. A method of making a plurality of conductive elements, comprising:
providing a conductive material,
forming from the conductive material a plurality of first regions configured for establishing at least one current path with a terminal of an energy storage device,
forming from the conductive material a plurality of second regions configured for establishing at least one current path with a current collector of the energy storage device,
separating at least one first region and an associated second region from the conductive material.

23. An energy storage device, comprising:
a terminal,
a current collector, the terminal and the current collector being configured for arrangement relative to a common axis, and
a conductive element, the conductive element comprising a first region configured for establishing at least one current path between the conductive element and the terminal and a second region configured for establishing at least one current path between the conductive element and the current collector,
whereby at least one current path between the terminal and the current collector is established via the conductive element irrespective of orientation of the conductive element relative to the common axis.

24. The energy storage device of claim 23, wherein the at least one current path between the conductive element and the current collector is established after at least one current path between an electrode of the energy storage device and the current collector is established.

25. The energy storage device of claim 23, wherein the at least one current path between the conductive element and the current collector is established after an electrode of the energy storage device and the current collector are mutually positioned.

26. The energy storage device of claim 23, wherein the energy storage device comprises an electrode and a container and wherein the at least one current path between the conductive element and the current collector is established after the electrode, the current collector and the container are mutually positioned.

27. The energy storage device of claim 23, wherein the at least one current path between the conductive element and the current collector is established after the at least one current path between the conductive element and the terminal is established.

28. The energy storage device of claim 23 comprising at least one surface variation in the first region of the conductive element configured to enhance at least one current path between the conductive element and the terminal.

29. The energy storage device of claim 23 comprising at least one surface variation in the first region of the conductive element configured to increase the number of current paths between the conductive element and the terminal.

30. The energy storage device of claim 23 wherein the number of current paths between the conductive element and the terminal is not less than 2.

31. The energy storage device of claim 23 comprising an area of contact between the conductive element and the terminal and comprising at least one surface variation in the first region of the conductive element configured to increase the area of contact between the conductive element and the terminal.

32. The energy storage device of claim 23 comprising at least one surface variation in the second region of the conductive element configured to enhance at least one current path between the conductive element and the current collector.

33. The energy storage device of claim 23 comprising at least one surface variation in the second region of the conductive element configured to increase the number of current paths between the conductive element and the current collector.

34. The energy storage device of claim 23 wherein the number of current paths between the conductive element and the current collector is not less than 2.

35. The energy storage device of claim 23 comprising an area of contact between the conductive element and the current collector and comprising at least one surface variation in the second region of the conductive element configured to increase the area of contact between the conductive element and the current collector.

36. The energy storage device of claim 23 comprising at least one aperture disposed in the conductive element between the first region and the second region.

37. The energy storage device of claim 23 wherein the first region comprises at least one surface variation for establishing at least one current path between the conductive element and the terminal and wherein the second region comprises at least one surface variation for establishing at least one current path between the conductive element and the current collector.

38. The energy storage device of claim 23 wherein the at least one surface variation for establishing at least one current path between the conductive element and the terminal comprises a first plurality of surface variations, wherein the at least one surface variation for establishing at least one current path between the conductive element and the current collector comprises a second plurality of surface variations, and wherein the first plurality is greater than the second plurality.

39. The energy storage device of claim 23 wherein the conductive element is deformable.

40. The energy storage device of claim 39 wherein the conductive element is deformable into an S-shaped configuration.

41. The energy storage device of claim 39 wherein the conductive element is deformable into a Z-shaped configuration.

42. The energy storage device of claim 23 wherein the terminal comprises a central region and wherein the first region of the conductive element is configured for establishing at least one current path between the conductive element and the central region of the terminal.

43. The energy storage device of claim 23 wherein the current collector comprises a central region and wherein the second region of the conductive element is configured for establishing at least one current path between the conductive element and the central region of the current collector.

44. A method of making an energy storage device, comprising:
providing a terminal,
providing a current collector, the terminal and the current collector being configured for arrangement relative to a common axis,
providing a conductive element, the conductive element comprising a first region configured for establishing at least one current path between the conductive element and the terminal and a second region configured for establishing at least one current path between the conductive element and the current collector, and
establishing at least one current path between the terminal and the current collector via the conductive element irrespective of orientation of the conductive element relative to the common axis.

45. The method of claim 44, wherein the at least one current path between the conductive element and the current collector is established after at least one current path between an electrode of the energy storage device and the current collector is established.

46. The method of claim 44, wherein the at least one current path between the conductive element and the current collector is established after an electrode of the energy storage device and the current collector are mutually positioned.

47. The method of claim 44, wherein the energy storage device comprises an electrode and a container and wherein the at least one current path between the conductive element and the current collector is established after the electrode, the current collector and the container are mutually positioned.

48. The method of claim 44, wherein the at least one current path between the conductive element and the current collector is established after the at least one current path between the conductive element and the terminal is established.

49. The method of claim 44 comprising providing at least one surface variation in the first region of the conductive element configured to enhance at least one current path between the conductive element and the terminal.

50. The method of claim 44 comprising providing at least one surface variation in the first region of the conductive element configured to increase the number of current paths between the conductive element and the terminal.

51. The method of claim 44 wherein the number of current paths between the conductive element and the terminal is not less than 2.

52. The method of claim 44 comprising an area of contact between the conductive element and the terminal and comprising providing at least one surface variation in the first region of the conductive element configured to increase the area of contact between the conductive element and the terminal.

53. The method of claim 44 comprising providing at least one surface variation in the second region of the conductive element configured to enhance at least one current path between the conductive element and the current collector.

54. The method of claim 44 comprising providing at least one surface variation in the second region of the conductive element configured to increase the number of current paths between the conductive element and the current collector.

55. The method of claim 44 wherein the number of current paths between the conductive element and the current collector is not less than 2.

56. The method of claim 44 comprising an area of contact between the conductive element and the current collector and comprising providing at least one surface variation in the second region of the conductive element configured to increase the area of contact between the conductive element and the current collector.

57. The method of claim 44 comprising at least one aperture disposed in the conductive element between the first region and the second region.

58. The method of claim 44 wherein the first region comprises at least one surface variation for establishing at least one current path between the conductive element and the terminal and wherein the second region comprises at least one surface variation for establishing at least one current path between the conductive element and the current collector.

59. The method of claim 44 wherein the at least one surface variation for establishing at least one current path between the conductive element and the terminal comprises a first plurality of surface variations, wherein the at least one surface variation for establishing at least one current path between the conductive element and the current collector comprises a second plurality of surface variations, and wherein the first plurality is greater than the second plurality.

60. The method of claim 44 wherein the conductive element is deformable.

61. The energy storage device of claim 39 wherein the conductive element is deformable into an S-shaped configuration.

62. The energy storage device of claim 39 wherein the conductive element is deformable into a Z-shaped configuration.

63. The method of claim 44 wherein the terminal comprises a central region and wherein the first region of the conductive element is configured for establishing at least one current path between the conductive element and the central region of the terminal.

64. The method of claim 44 wherein the current collector comprises a central region and wherein the second region of the conductive element is configured for establishing at least one current path between the conductive element and the central region of the current collector.

65. The conductive element of claim 1 wherein the current collector comprises a radially symmetric configuration.

66. The conductive element of claim 1 wherein the terminal comprises a cover.

67. The energy storage device of claim 23, wherein the current collector comprises a radially symmetric configuration.

68. The energy storage device of claim 23, wherein the terminal comprises a cover.

69. The method of claim 44, wherein the current collector comprises a radially symmetric configuration.

70. The method of claim 44, wherein the terminal comprises a cover.

71. A conductive element comprising:
a first region configured for establishing at least one current path between the conductive element and a terminal of an energy storage device,
a second region configured for establishing at least one current path between the conductive element and a current collector of the energy storage device,
the terminal and the current collector being configured for arrangement relative to a common axis, the conductive element being configured for establishing at least one current path between the terminal and the current collector when the terminal and the current collector are arranged relative to the common axis.

72. An energy storage device, comprising:
a terminal,
a current collector, the terminal and the current collector being configured for arrangement relative to a common axis, and
a conductive element, the conductive element comprising a first region configured for establishing at least one current path between the conductive element and the terminal and a second region configured for establishing at least one current path between the conductive element and the current collector, the conductive element being configured for establishing at least one current path between the terminal and the current collector when the terminal and the current collector are arranged relative to the common axis.

73. A method of making an energy storage device, comprising:
providing a terminal,
providing a current collector, the terminal and the current collector being configured for arrangement relative to a common axis,
providing a conductive element, the conductive element comprising a first region configured for establishing at least one current path between the conductive element and the terminal and a second region configured for establishing at least one current path between the conductive element and the current collector, and
establishing at least one current path between the terminal and the current collector via the conductive element.

74. A method of making at least one conductive element, comprising:
providing a conductive material,
forming from the conductive material at least one first region configured for establishing at least one current path with a terminal of an energy storage device,
forming from the conductive material at least one second region configured for establishing at least one current path with a current collector of the energy storage device.

75. A method comprising:
providing an energy storage device comprising a terminal, a current collector and a conductive element, the conductive element comprising a first region configured for establishing at least one current path between the conductive element and the terminal and a second region configured for establishing at least one current path between the conductive element and the current collector, and
reducing effective electrical resistance of the energy storage device by establishing at least one electrical current path between the terminal and the current collector via the conductive element.

76. A method comprising:
providing an energy storage device comprising a terminal, a current collector and a conductive element, the conductive element comprising a first region configured for establishing at least one current path between the conductive element and the terminal and a second region configured for establishing at least one current path between the conductive element and the current collector, and
decreasing energy cell operating temperature by establishing at least one electrical current path between the terminal and the current collector via the conductive element.

77. A method comprising:
providing an energy storage device comprising a terminal, a current collector and a conductive element, the conductive element comprising a first region configured for establishing at least one current path between the conductive element and the terminal and a second region configured for establishing at least one current path between the conductive element and the current collector, and
increasing energy storage device efficiency by establishing at least one electrical current path between the terminal and the current collector via the conductive element.

78. A method comprising:
providing an energy storage device comprising a terminal, a current collector and a conductive element, the conductive element comprising a first region configured for establishing at least one current path between the conductive element and the terminal and a second region configured for establishing at least one current path between the conductive element and the current collector, and
increasing energy storage device longevity by establishing at least one electrical current path between the terminal and the current collector via the conductive element.

79. A method comprising:
providing an energy storage device comprising a terminal, a current collector and a conductive element, the conductive element comprising a first region configured for establishing at least one current path between the conductive element and the terminal and a second region configured for establishing at least one current path between the conductive element and the current collector, and
increasing energy storage device current capacity by establishing at least one electrical current path between the terminal and the current collector via the conductive element.

80. The energy storage device of claim 23 comprising a coil comprising at least one electrode, the coil comprising an outer diameter and an inner diameter, the outer diameter and the inner diameter defining a ratio of not less than 6 to 1.

81. The method of claim 44 wherein the energy storage device comprises a coil comprising at least one electrode, the coil comprising an outer diameter and an inner diameter, the outer diameter and the inner diameter defining a ratio of not less than 6 to 1.

82. A method comprising:
providing an energy storage device comprising a terminal, a current collector and a conductive element, the terminal and the current collector being configured for arrangement relative to a common axis, the conductive element comprising:
a first region configured for establishing at least one current path between the conductive element and the terminal of the energy storage device,
a second region configured for establishing at least one current path between the conductive element and the current collector of the energy storage device,
whereby at least one current path between the terminal and the current collector is established via the conductive element irrespective of orientation of the conductive element relative to the common axis, and
accessing energy stored in the energy storage device.

83. An apparatus comprising:
an energy storage device, and
a configuration enabling use of energy stored in the energy storage device,
the energy storage device comprising a terminal, a current collector and a conductive element, the terminal and the current collector being configured for arrangement relative to a common axis, the conductive element comprising:
a first region configured for establishing at least one current path between the conductive element and the terminal of the energy storage device,
a second region configured for establishing at least one current path between the conductive element and the current collector of the energy storage device,
whereby at least one current path between the terminal and the current collector is established via the conductive element irrespective of orientation of the conductive element relative to the common axis.
